(19) United States
(12) Patent Application Publication
(10) Pub. No.: US 2009/0255080 A1
(43) Pub. Date: Oct. 15, 2009

(54) Back scrubbing device & method of manufacturing same

(76) Inventor: Daniel T. Lozinik, Calgary (CA)

Correspondence Address: DIEDERIKS & WHITELAW, PLC, 12471 Dillingham Square, #301, Woodbridge, VA, 22192, US

(21) Appl. No.: 12/078,984

(22) Filed: Apr. 9, 2008

(51) Int. Cl. A47K 7/02; B23P 11/00

(52) U.S. Cl. 15/229.13; 15/229.12; 15/229.11; 29/428

(57) ABSTRACT

An improved back scrubber device comprised of an exfoliation part suspended between two flexible handles, all of sufficient combined length to accommodate a human to apply pressure to, and move against, that same human's back or other hard-to-reach parts of that human's body. The exfoliant part may be a loofah. The handles may be cord or rope. The handles may be formed of one length of flexible cord or rope extended through the exfoliation part's body longitudinally, and held from sliding therethrough by a washer and fastener at each end of the exfoliant part.

### FIELD OF THE INVENTION

The present invention relates generally to an improved back scrubber device.

### BACKGROUND OF THE INVENTION

The desirability of a satisfactory means of scrubbing one's back has long been recognized.

Representative examples of back-scrubbing systems may be found in U.S. Pat. No. 1,379,925 (Kawasaki) (“925”), U.S. Pat. No. 6,058,545 (Roach) (“545”), U.S. Pat. No. 5,537,709 (Taragos) (“709”), U.S. Pat. No. 4,014,051 (Pettit) (“051”), U.S. Pat. No. 5,517,705 (Jackson) (“705”), U.S. Pat. No. 2,318,680 (Ellinger) (“680”), U.S. Pat. No. 3,085,276 (Swanson) (“276”), U.S. Pat. No. 3,124,822 (Marchese) (“822”), US D465,613 (Pierce) (“613”), U.S. Pat. No. 3,805,314 (De Bel) (“314”), U.S. Pat. No. 6,026,531 (Pruitt) (“531”) and U.S. Pat. No. 3,345,669 (Starry) (“669”).

'925 Kawasaki provides for a unitary flat, wide flexible but torsionally rigid belt with finger holes and a removable flat scrubbing surface snapped on the middle of the belt.

'545 Roach provides for a moving endless belt of scrubbing material attached to a motorized apparatus affixed to the bathtub wall against which a user might lean to scrub his or her back.

'709 Taragos provides for an elongate molded flexible belt formed of a moldable yieldable material having a front and rear surface and having attached thereto in approximately the centre a removable scrubbing pad impregnated with soap. This is reminiscent of '925 Kawasaki.

'051 Pettit provides for a scratching and scrubbing device adapted for attachment to the wall of a shower or bath area by suction cups, and with or without water supplied through the scrubbing area. The user is meant to lean into the device while it is attached to the wall, and move his or her body to obtain the scrubbing or scratching effect desired.

'705 Jackson also provides for a back scrubbing device attached to the wall of a shower or bathing area, in this case including the dispensing of soap and water through the scrubbing surface.

'680 Ellinger provides for a part of relatively rigid but resilient cable arms configured (with a brush part) in a “U” shape with handles fixed at each end, in the middle of which is fixed a scrubbing brush with bristles 360 degrees around its longitudinal axis, the brush attached together with the two cable arms forming the “U”. The cable is in this case relatively rigid. As well the brush is permanently affixed at each of its ends to the relatively rigid cable arms, which project outwards and are bent to accommodate a gripping of the handles at each opposite end by a user, the gripping being done in front of the user's body while scrubbing the back.

'276 Swanson provides for a rigid U shaped frame: in the inside of the U is an affixed scrubbing surface, the U being of a shape and size to be capable of reaching around the back and the front of a human user's torso, and manipulated by one hand.

'822 Marchese provides for a flexible belt with a handle at each end at the middle of which is a flat scrubbing block, permanently affixed.

'531 Pruitt provides for a rigid but flexible frame with a torso contacting device provided with a scrubbing or cleaning surface, the arc frame reaching around from the back of the operator to his hands at the front. This is, essentially, a long double-handled brush device, meant to permit a person of limited mobility to maintain is or her arms in front of his or her trunk while massaging or cleaning his or her back.

'669 Starry provides a sponge cleaning device which is a long bar bent at one end with a head to which may be affixed a removable sponge; another form of long-handled brush device.

There are a variety of disadvantages to the prior art, including without limitation, difficulty in storage, use of non-recyclable materials, inability to be adjusted to suit particular user's shapes, sizes, and preferences, complicated operation, assembly and maintenance, need for affixation at a wall, and et cetera. It remains desirable within the art to provide an improved back scrubber and method of use and of assembly of the same to overcome at least one of those deficiencies or disadvantages.

### SUMMARY OF THE INVENTION

It is an object of the present invention to obviate or mitigate at least one disadvantage of previous back scrubbers.

The present invention relates generally to an improved back scrubber device comprised of an exfoliation part suspended between two flexible handles, all of sufficient combined length to accommodate a human to apply pressure to, and move the exfoliant part against, that same human's back or other hard-to-reach parts of that human's body, with the device. The exfoliant part may be a loofah. The handles may be cord or rope. The handles may be formed of one length of flexible cord or rope extended through the exfoliation part's body longitudinally, and held from sliding therethrough by washers and knots or fasteners; the cord may be different colors, one device to another, to (for example) differentiate ownership in a shared environment.

In a first aspect, the present invention provides a personal hygiene skin scrubbing device useful for reaching parts of a user's body which are ordinarily out of easy reach of the user's hands, comprising, a roughly cylindrical scrubbing body with an abrasive surface through which body is threaded a cord, the cord having two ends and being held from sliding in the body while the device is in use and being moveable within the body to adjust the relative lengths of the cord from each end to the closest surface of the body.

In a further embodiment, the back scrubber includes a loofah.

In a further embodiment, the back scrubber may be a personal hygiene skin scrubbing device useful for reaching parts of a user's body which are ordinarily out of easy reach of the user's hands, comprising, a roughly cylindrical scrubbing body with an abrasive surface through which body is threaded a colored cord, the cord having two ends and being held from sliding in the body while the device is in use and being moveable within the body to adjust the relative lengths of the cord from each end to the closest surface of the body, where the cord is held from sliding within the body by a clip removably fixed to the cord against a washer, which may be one of a number of different functional but identifying shapes, located on the cord adjacent to an end of the body, and a similar clip and washer assembly on the cord adjacent to the other end of the body.

In a further aspect is provided a method of use of the above back scrubber, entailing the steps of having an operator holding one end of the cord in each hand with the body touching the skin of the operator and moving the cord ends in a coordinated fashion and moving the body against the skin and simultaneously exerting a force of the body against the skin of the operator as desired by the operator.

In another aspect is provided a method whereby the back scrubber is assembled of the following parts using the following steps: loofahs are received flat and dry. Dried loofahs are deposited into a body of water big enough to accommodate expansion of same. After 5 minutes of loofahs soaking in water, they are stacked onto a rack to allow drainage of excess water for approximately 1 hour. Loofahs are then hung flat on 2 parallel pieces of string to air-dry overnight.

Loofahs 1 are measured to specific length and cut. Insertion of a wooden dowel 60 (with a fishing line 80 attached to an eyelet 65 in the wooden dowel 60 by a loop 70 formed in the fishing line 80 by a knot 75) into the loofah 1 takes place, and must exit the other end preferably in the middle of the cut section. The fishing line 80 that's attached to the wooden dowel 60 has a slip knot 85 incorporated into the end of the fishing line 80 to removably connect to a nylon cord 16 to pull the nylon cord 16 back through the passage made by the wooden dowel 65 in the loofah 1.

The nylon cord 16 is balanced out for length and a rubber washer 35, 40 is applied to either end, and the stopper or clip 50 is added to complete the construction of all components.

The nylon cord 16 is then fitted with a knot 20 at either end to form a looped handle 25 for the product user to hold onto and adjust for their exact specifications.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a side elevation sketch of the back scrubber;

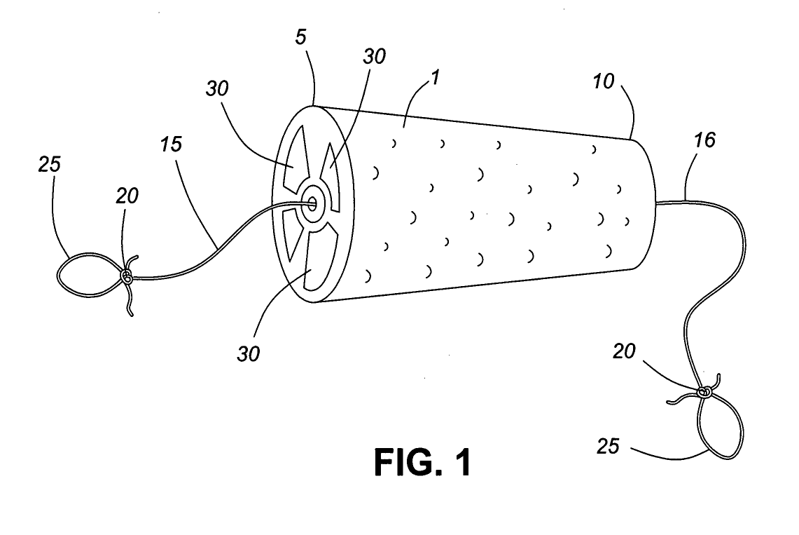

FIG. 2 is a schematic side elevation view of the back scrubber, with FIGS. 2A and 2B showing an end-view of component washers; and

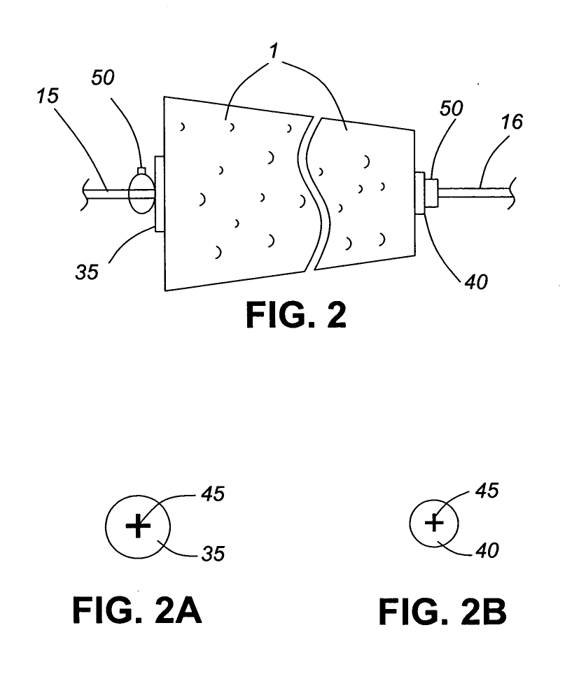

FIG. 3 is a side elevation sketch of a wooden dowel.

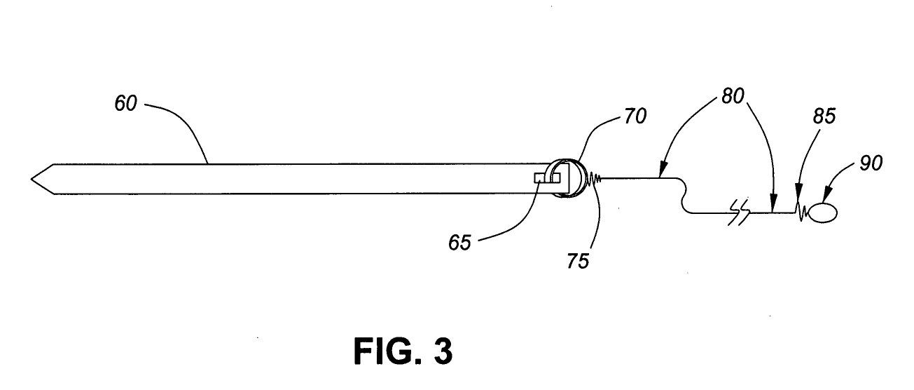

### DETAILED DESCRIPTION

The present invention relates to an apparatus and method for scrubbing one's back, or other parts of one's body which are different to reach, as a part of one's personal hygiene. The present apparatus allows a user to reach parts of his or her body which are ordinarily inaccessible, and to apply pressure and movement of the scrubbing surface to the skin sufficient to provide some exfoliation or stimulation to the skin's surface where deployed.

### The Apparatus

The scrubber is constructed, in a preferred embodiment, of a length of loofah sponge (dried and processed ridged gourd, luffa acutangula or luffa aegytiaca) 1, but can be of any roughly cylindrical material with a texture and sufficient body rigidity to serve as a body scrubbing sponge. Through the longitudinal centre of the loofah 1 is threaded a nylon cord or rope 15, 16. At each end of the nylon cord or rope 15, 16 is formed a looped handle 25, typically by forming a knot 20; the looped handles 25 are meant to be handles for the operator.

To keep the nylon cord or rope 15, 16 from sliding through the loofah 1 when the device is moved longitudinally across the user's dermis, a stopper or clip 50 is moveably fixed to the nylon cord or rope 15, 16 against a rubber washer 35 through a slit at the center of which 45 is passed the nylon cord or rope 15, 16; that sub-assembly of rubber washer 35 and stopper or clip 50 being fixed at each end of the loofah 1. The sub-assemblies of rubber washers 35 and stopper or clip 50 may be moved so that the loofah 1 can be moved along the length of the nylon cord or rope 15, 16 to accommodate the preference of a user to have the looped handle 25 at one end of the nylon cord or rope 15 closer or further from the end of the loofah 1 than the looped handle 25 at the other end of the nylon cord or rope 16; this might be more desirable for a user to reach and scrub certain parts of the user's body than a configuration of equally spaced looped handles 25. The stopper or clip 50 may be any of a number of commercially available clips, toggles, grommet and locks or similar devices.

The nylon cord or rope 15, 16 may be colored, with one device having a different colored nylon cord or rope 15, 16 from another, permitting a user to differentiate amongst similar devices. This may be useful in a shared environment such as a family bath facility. Similarly, the rubber washer, 35 and stopper or clip 50 may be of different colors or shapes or styles.

Furthermore, in the embodiment shown in the Figures, the present device is designed to be easy to use without any training or instruction, easy to assemble or manufacture, durable, hangable, easy to dry, and preferably made from environmentally friendly materials.

Additionally, there is provided a method of use and a method of assembly or manufacture of the apparatus claimed, each of which provides improvements over prior methods.

### Method of Operation

When used by a human operator to scrub portions of the operator's body which are otherwise not easily reached, the operator holds one looped handle 25 in each hand, with the loofah 1 against the operator's body. For instance, if scrubbing the operator's back, in one case the operator's hand may hold one looped handle 25 above one shoulder, the other hand holding the other looped handle 25 below the other shoulder, with the loofah 1 behind the operator's back and the operator could then, using a see-sawing or reciprocating motion, move the looped handles 25 back and forth while exerting sufficient tension on the nylon cord or rope 15, 16, such that the loofah 1 moves against the operator's skin with sufficient frictional effect to cause a desired scrubbing or exfoliation of the dermis. Obviously, other motions are possible, and the relative length of the nylon cord or rope 15, 16 extending past the loofah 1 to the looped handles 25 will accommodate a variety of operator actions.

### Method of Manufacture or Assembly

Loofahs are received flat and dry. Dried loofahs are deposited into a body of water large enough to accommodate expansion of same. After 5 minutes of loofahs soaking in water, they are stacked onto a rack to allow drainage of excess water for approximately 1 hour. Loofahs are then hung flat on 2 parallel pieces of string to air-dry overnight.

Loofahs 1 are measured to specific length and cut. Insertion of a wooden dowel 60 (with a fishing line 80 attached to an eyelet 65 in the wooden dowel 60 by a loop 70 formed in the fishing line 80 by a knot 75) into the loofah 1 takes place, and must exit the other end preferably in the middle of the cut section. The fishing line 80 that's attached to the wooden dowel 60 has a slip knot 85 incorporated into the end of the fishing line 80 to removably connect to a nylon cord or rope 16 to pull the nylon cord or rope 16 back through the passage made by the wooden dowel 65 in the loofah 1.

The nylon cord or rope 16 is balanced out for length and a rubber washer 35, 40 is applied to either end, and the stopper or clip 50 is added to complete the construction of all components.

The nylon cord or rope 16 is then fitted with a knot 20 at either end to form a looped handle 25 for the product user to hold onto and adjust for their exact specifications.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A personal hygiene skin scrubbing device useful for reaching parts of a user's body which are ordinarily out of easy reach of the user's hands, comprising:
a. a roughly cylindrical scrubbing body with an abrasive surface;
b. through which body is threaded a cord;
c. the cord having two ends;
d. the cord being held from sliding in the body while the device is in use; and
e. the cord being moveable within the body to adjust the relative lengths of the cord from each end to the closest surface of the body.
f.

2. The apparatus of claim 1 where the cord is coloured.

3. The apparatus of claim 1 where the body is a segment of loofah sponge.

4. The apparatus of claim 1 where the body is between 9 and 14 inches in length.

5. The apparatus of claim 1 where the body is between 2 and 6 inches in diameter.

6. The apparatus of claim 1 where the cord is held from sliding within the body by a clip removably fixed to the cord against a washer located on the cord adjacent to an end of the body, and a similar clip and washer assembly on the cord adjacent to the other end of the body.

7. The apparatus of claim 6 where the clip is coloured.

8. The apparatus of claim 6 where a washer is coloured or of a different exterior shape (such as a star shape).

9. The apparatus of claim 1 where the ends of the cord have handles.

10. A method of use of the personal hygiene skin scrubbing device of claim 1, comprising the steps of:
g. having an operator holding one end of the cord in each hand;
h. with the body touching the skin of the operator;
i. moving the cord ends in a coordinated fashion; and
j. to move the body against the skin and simultaneously exert a force of the body against the skin of the operator as desired by the operator.
k.

11. A method of assembly or manufacture of the personal hygiene skin scrubbing device of claim 1, comprising the steps of:
l. dried loofahs are deposited into a body of water big enough to accommodate expansion of same. After 5 minutes of loofahs soaking in water, they are stacked onto a rack to allow drainage of excess water for approximately 1 hour. Loofahs are then hung flat on 2 parallel pieces of string to air-dry overnight;
m. loofahs are measured to specific length and cut. Insertion of a wooden dowel (with a fishing line attached to an eyelet in the wooden dowel by a loop formed in the fishing line by a knot) into the loofah takes place, and must exit the other end preferably in the middle of the cut section. The fishing line that's attached to the wooden dowel has a slip knot incorporated into the end of the fishing line to removeably connect to a nylon cord to pull the nylon cord back through the passage made by the wooden dowel in the loofah;
n. the nylon cord is balanced out for length and a rubber washer is applied to either end, and the stopper or clip is added to complete the construction of all components; and
o. the nylon cord is then fitted with a knot at either end to form a looped handle for the product user to hold onto and adjust for their exact specifications.
